(19) United States
(12) Patent Application Publication
(10) Pub. No.: US 2026/0159053 A1
(43) Pub. Date: Jun. 11, 2026

(54) BRAKE PRESSURE GENERATOR

(71) Applicant: ZF Active Safety GmbH, Koblenz (DE)

(72) Inventors: Frank Kreutzer, Braubach (DE); Manoel-Simon Pippi, Bonn (DE)

(21) Appl. No.: 19/413,411

(22) Filed: Dec. 9, 2025

(30) Foreign Application Priority Data
Dec. 11, 2024 (DE) 102024137258.3

(51) Int. Cl. B60T 11/16

(52) U.S. Cl. CPC B60T 11/165

(57) ABSTRACT

The brake pressure generator 1 according to the invention comprises a hydraulic block 5 having a brake cylinder bore 6. A piston 30 with a pressure side 33, which projects into the brake cylinder bore 6, and with a coupling side 35, for coupling the piston 30 to an actuating rod 25, extends along a piston longitudinal axis 31 between the pressure side 33 and the coupling side 35. A receiving element 50 comprises a connecting section 55 and a sliding guide 70. A guide rod 10 fastened to the hydraulic block 5 and offset and oriented parallel to the piston 30 is at least partially engaged around by the sliding guide 70, with the result that the piston 30 can slide along the guide rod 10 during an axial movement. Between the coupling side 35 and the connecting section 55, an axial form fit 80 acts, which at least primarily prevents the receiving element 50 from being released from the piston 30 in the axial direction 8. In addition, a circular form fit 81 acts between the coupling side 35 and the connecting section 55, which at least primarily prevents a rotation of the receiving element 50 relative to the piston 30. The invention also relates to a corresponding piston arrangement 20.

### TECHNICAL FIELD

The invention relates to a brake pressure generator for motor vehicles, in particular for passenger cars. The invention also relates to a piston arrangement for a brake pressure generator of this type.

### BACKGROUND

In the case of corresponding brake pressure generators, the brake piston or the brake pistons is/are mounted in an axially displaceable manner in a brake cylinder bore of a hydraulic block. Brake pressure generators of different designs are known. There are brake pressure generators with an individual piston (also called individual master brake cylinder) and there are brake pressure generators with a tandem piston (also called tandem master brake cylinder). Furthermore, there are brake pressure generators which are coupled to a brake booster (vacuum, electromechanical or hydraulic). Furthermore, brake pressure generators have been used for some time, which have a master brake cylinder, in particular a tandem master brake cylinder, a displacement transducer and simulator coupled to the master brake cylinder, an electromechanically operated additional pressure source and solenoid valves actuated by means of an electronic controller. Such brake pressure generators are, for example, “integrated brake systems” or “single box systems”.

Such a brake pressure generator is described in the laid-open specification DE 10 2022 103 976 A1.

The invention can be used in principle for various designs of brake pressure generators. However, it preferably relates to the integrated brake systems mentioned. If the term piston is used in the present case, this should preferably be understood to mean the primary piston of a tandem piston.

### SUMMARY

The object of the present invention is to provide a brake pressure generator which can be produced inexpensively and can be assembled in a simple and functionally appropriate manner. The same object also applies to the piston arrangement to be provided.

These objects are achieved according to the invention by a brake pressure generator having the features of claim 1 and by a piston arrangement having the features of claim 10. Advantageous embodiments of the invention are specified in subclaims 2 to 9.

The brake pressure generator according to the invention comprises a hydraulic block with a brake cylinder bore, a piston with a pressure side which projects into the brake cylinder bore, and a coupling side for coupling the piston to an actuating rod, wherein the piston extends along a piston longitudinal axis between the pressure side and the coupling side. Furthermore, the brake pressure generator comprises a receiving element with a connecting section and a sliding guide; and the brake pressure generator comprises a guide rod which is fastened to the hydraulic block and is offset and oriented parallel to the piston.

The sliding guide engages around the guide rod at least partially, with the result that, during an axial movement of the piston, the sliding guide can slide along the guide rod. An axial form fit which at least primarily prevents the receiving element from being released from the piston in the axial direction acts between the coupling side and the connecting section. Furthermore, a circular form fit which at least primarily prevents a rotation of the receiving element relative to the piston acts between the coupling side and the connecting section.

The reference for the description “axial” or “in the axial direction” is in the present case the piston longitudinal axis which preferably coincides with the bore axis of the brake cylinder bore. The terms mean an orientation or extent of an element, a movement or force effect along the piston longitudinal axis or along a direction parallel to the piston longitudinal axis.

The fact that the axial form fit at least primarily prevents the receiving element from being released from the piston in the axial direction means that it is designed such that it acts in the axial direction. However, this does not rule out the possibility that this form fit also results in other forces such as, for example, clamping forces which counteract a rotation of the receiving element with respect to the piston. However, the actual form fit acts in the axial direction. Analogously, the circular form fit is to be understood to mean that it mainly prevents a rotation of the receiving element relative to the piston.

As a result of the axial and the circular form fit, the receiving element can be mounted on the piston in a simple and functionally reliable manner. The simple and thus faster assembly also results in a cost advantage. In a particular way, the circular form fit contributes to functionally reliable assembly, since said form fit specifies the angular position of the receiving element with respect to the piston, which is necessary for functional capability, and therefore incorrect assembly is virtually ruled out. The correct angular position of the receiving element is additionally achieved via the guide rod in interaction with the sliding guide.

A first form-fitting geometry, which is encompassed by the coupling side, and a second form-fitting geometry, which is encompassed by the connecting section, preferably form the axial form fit.

Here, a third form-fitting geometry, which is encompassed by the coupling side, and a fourth form-fitting geometry, which is encompassed by the connecting section, form the circular form fit. This division likewise facilitates assembly. Thus, for example, when the receiving element is mounted on the piston, the circular form fit first of all and then the axial form fit come into engagement successively, or vice versa. It also contributes to the functional reliability.

The axial form fit is preferably formed by an annular web, preferably an annular web present on the coupling side, engaging behind into a corresponding wall recess, preferably into a wall recess present on the receiving element. The wall recess is preferably a bore recess. This can also be an annular groove.

The axial form fit can alternatively be an annular, non-releasable snap-action closure. The above-described axial form fit, comprising an annular web and a corresponding wall recess, can also form such a snap-action closure. “Non-releasable” means that, although it is readily possible to mount the receiving element on the piston, it is generally not possible to release it in a non-destructive manner. This configuration thus likewise contributes to the functional reliability.

Alternatively or additionally, the axial form fit can also be formed by an annular web situated on the receiving element, preferably in a receiving bore of the receiving element, engaging behind into an annular groove, situated on the coupling side, or into a wall recess situated on the coupling side.

The circular form fit is preferably formed according to the groove and tongue principle. The circular form fit can be formed by an axially running groove or an axially running slot in the coupling side and an axially running web on the receiving element. This variant favours simple assembly, since, at least in the case of the axially extending slot, during the assembly of the receiving element, the corresponding region of the piston or of a connecting shoulder belonging to the piston and situated on the coupling side thereof can yield somewhat resiliently and can subsequently spring open again.

The receiving element is preferably plugged onto a connecting shoulder situated on the coupling side by means of a connecting bore situated in the connecting section. In this case, both the axial form fit and the circular form fit are encompassed by the connecting bore and the connecting shoulder. That is to say, the above-described form fits are arranged in the connecting shoulder, in the region of the connecting shoulder or in the region of the connecting bore. Specifically, for example, the first form-fitting geometry and the third form-fitting geometry are encompassed by the connecting shoulder.

In one preferred refinement of the brake pressure generator, the sliding guide is arranged on a tab which projects radially from the connecting section. “Radially” denotes a direction which extends radially starting from the piston longitudinal axis.

The receiving element preferably has a collar which extends radially outward from the connecting section and is connected to the tab. Said collar serves to receive a compression spring.

In one particularly preferred embodiment of the brake pressure generator according to the invention, the receiving element is formed in one piece and is produced from a technical plastic. The plastic is preferably a polyamide or a fibre-reinforced polyamide. The one-piece nature results in cost advantages. Separate sliding inserts are not necessary here. Furthermore, the technical plastics mentioned ensure the strength necessary for a functionally appropriate assembly.

The receiving element is preferably a plastic injection-moulded part, since such components can be produced inexpensively.

At least one transducer for sensing the travel of the piston is preferably arranged in the piston in such a way that the centre of gravity of the at least one transducer is spaced apart from the piston longitudinal axis. The at least one transducer is preferably a permanent magnet, with the result that, in this case, the centre of gravity of the permanent magnet is preferably spaced apart from the piston longitudinal axis. The position of the transducer is preferably determined by means of a Hall sensor, for example a 3D Hall sensor. The transducer, which is arranged eccentrically with respect to the piston longitudinal axis, can, in interaction with the aforementioned features of the invention, in particular with the circular form fit, be moved in a functionally reliable manner into the position, in which recording of the travel is ensured by means of the sensor.

A brake pressure generator also lies within the conceivable spectrum of the invention, which is designed according to one of the preceding embodiments but in which, instead of the presence of the axial form fit and the circular form fit, only one of the two form fits is present, and wherein the receiving element is a single-piece plastic injection-moulded part, wherein one of the abovementioned further specifications of the type of plastic can be present.

The piston arrangement according to the invention can be used in a brake pressure generator, as described above. The piston arrangement comprises a piston and a receiving element corresponding to one or more of the aforementioned embodiments. The features, technical effects and advantages already mentioned also apply correspondingly to the piston arrangement.

### BRIEF DESCRIPTION OF THE DRAWINGS

Further features, advantages and possibilities of use of the present invention result from the following description of exemplary embodiments and the diagrammatic FIGS. 1 to 5. For the sake of clarity, not all of the illustrated elements in a figure are also provided with a reference sign. However, corresponding elements or regions are then identified at least in another figure, and the meaning can be gathered therein. In the figures, furthermore, the same reference symbols can represent identical or similar objects.

FIG. 1 shows one exemplary embodiment of the brake pressure generator according to the invention in a partial view and sectional illustration,

FIG. 2 shows one exemplary embodiment of the piston arrangement according to the invention,

FIG. 3 shows one exemplary embodiment of the piston arrangement according to the invention in a full section,

FIG. 4 shows one exemplary embodiment of the piston,

FIG. 5 shows a part region of the piston, and

FIG. 6 shows one exemplary embodiment of the receiving element.

### DESCRIPTION

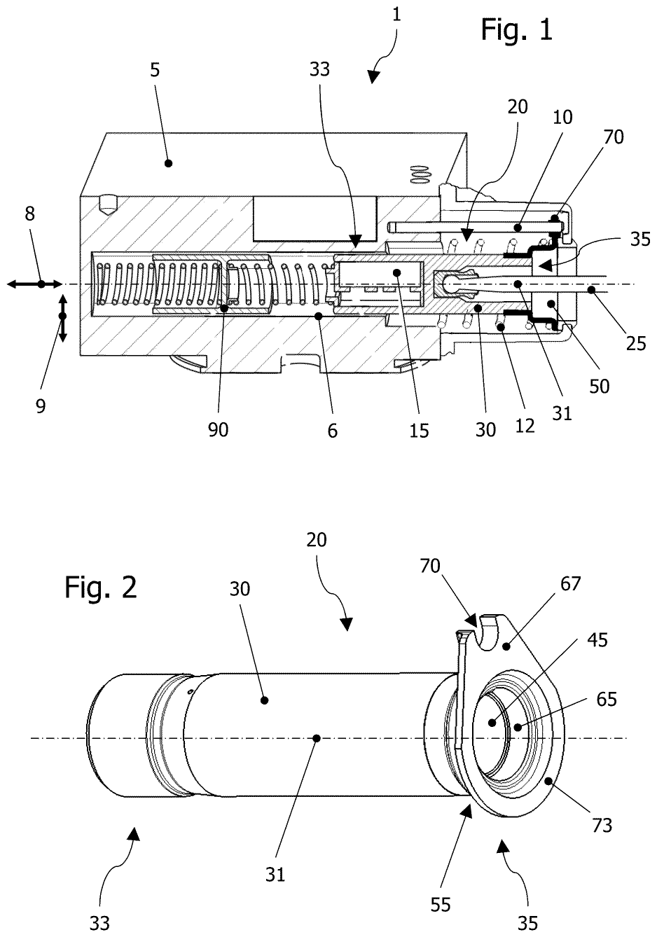

The brake pressure generator 1 illustrated in FIG. 1 comprises a hydraulic block 5 with a brake cylinder bore 6, in which a primary piston 30 (hereinafter referred to as only “piston”) and a secondary piston 90 are mounted so as to be axially displaceable. The piston 30 and the secondary piston 90 are coupled to one another hydraulically and by means of a compression spring. The piston 30 extends along a piston longitudinal axis 31 between a pressure side 33, which projects into the brake cylinder bore 6, and a coupling side 35, which projects out of the brake cylinder bore 6 and out of the hydraulic block 5. Within the piston 30, a transducer 15 in the form of a permanent magnet is inserted on the pressure side 33 eccentrically with respect to the piston longitudinal axis 31. On the coupling side 35, the piston 30 is coupled to an actuating rod 25, by way of which the piston 30 can be actuated or displaced.

It can be seen in FIGS. 4 and 5 that the coupling side 35 additionally has a connecting shoulder 45 at the outer end of the piston 30. The connecting shoulder 45 is sleeve-shaped, wherein its outer diameter is smaller than the outer diameter of the rest of the piston 30. At the outermost end of the connecting shoulder 45 and thus also at the outermost end of the coupling side 35, the connecting shoulder 45 has an annular web 40 with an insertion bevel, which increases the diameter of the connecting shoulder 45 in this region in relation to an adjacent region of the connecting shoulder 45. Furthermore, the connecting shoulder 45 has a slot 42 which extends in the axial direction 8 and correspondingly cuts out the connecting shoulder 45.

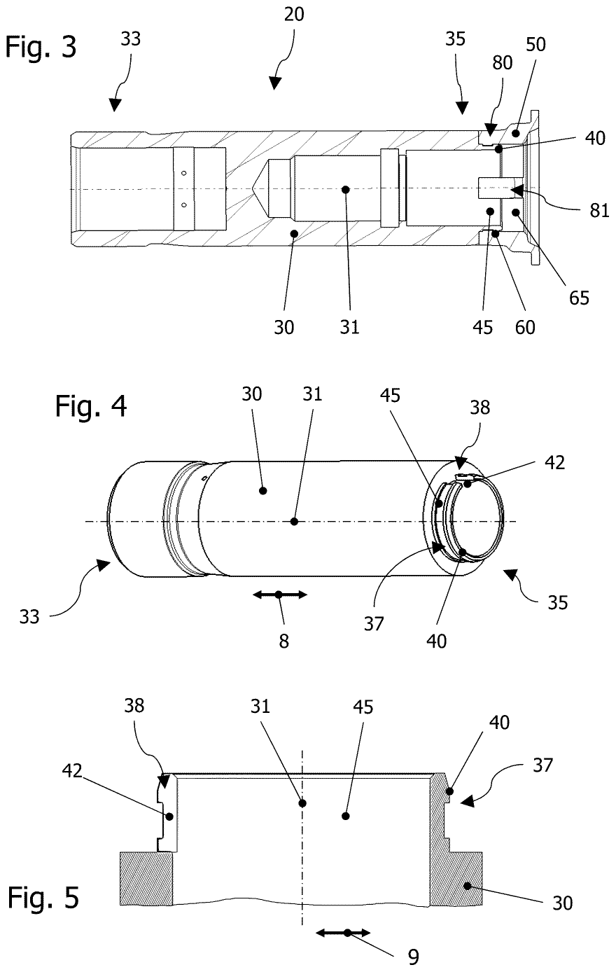

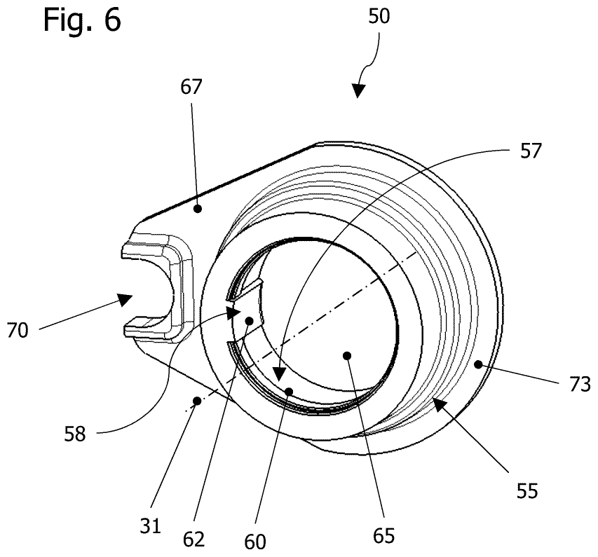

A receiving element 50, which is illustrated in FIG. 5, is plugged onto the connecting shoulder 45 by means of a connecting bore 65 made in the receiving element 50. The piston arrangement 20 with the piston 30 and the receiving element 50 joined together is illustrated in FIG. 3 in the form of a full section. The receiving element 50 comprises a connecting section 55 and a sliding guide 70. The connecting section 55 is penetrated by the connecting bore 65. The connecting bore 65 has a wall recess 60, such that the connecting bore 65 increases in diameter as a result.

The annular web 40 is latched on said wall recess 60 or into the enlarged region of the connecting bore 65, with the result that the receiving element 50 is securely fixed in a form-fitting manner on the piston 30 in the axial direction 8. The annular web 40 and the wall recess 60 thus form the axial form fit 80.

Conversely, in this exemplary embodiment, it could also be described in such a way that an annular groove is made in the connecting shoulder 45, as a result of which the annular web 40 is enlarged radially outward relative to said annular groove, and that a projecting bore part engages into said annular groove.

In the connecting bore 65, a web 62, which could also be referred to as a type of tongue and the longitudinal extent of which runs axially, projects out of its bore wall. The width of the web 62 is dimensioned such that it engages into the slot 42. By means of this circular form fit 81, the receiving element 50 is secured in a form-fitting manner against rotation with respect to the piston 30.

On the side which lies closer to the outer end of the connecting shoulder 45, the connecting section 55 of the receiving element 50 has a collar 73 which projects outward in the radial direction 9. The compression spring 12, which has a retraction function, is supported on this collar 73, in order that the piston 30 is pushed back into a starting position after the actuating rod 25 has been retracted, that is to say the brake has been released. On the side which lies opposite the collar 73, the compression spring 12 is supported on the hydraulic block 5.

The collar 73 is adjoined by a flat tab 67 which projects further radially outward. Arranged at the radially outer end of the tab 67 is a U-shaped sliding guide 70, the open side of which is directed radially outward. The sliding guide 70 is thicker in the axial direction 8 than the tab 67. The receiving element 50 is configured in one piece. That is to say, the sliding guide 70 also belongs to this, with the result that the plastic, from which the receiving element 50 is produced, itself has the necessary sliding property. The sliding guide 70 engages around a guide rod 10 which runs parallel to the piston 30 and at a distance therefrom. The guide rod 10 is fastened in a positionally fixed manner to the hydraulic block 5, with the result that, during an axial movement of the piston 30, the sliding guide 70 slides with the inner surfaces of its U-shaped region along the guide rod 10. This construction has the effect that the piston 30 assumes and maintains a functionally necessary angular position with respect to the hydraulic block 5 or with respect to a corresponding sensor (not illustrated) both during assembly and during operation.

Overall, the described brake pressure generator 1 is thus producible in a cost-effective, comparatively simple and functionally reliable manner.

FIGS. 2 and 3 show the piston arrangement 20 in an assembled form. That is to say, the above explanations relating to the axial form fit 80 and the circular form fit 81 are present here and can be seen, in particular, by the sectional illustration in FIG. 3.

The design according to the invention both of the piston arrangement 20 and of the brake pressure generator 1, in particular on account of the described embodiment of the form fits and of the single-piece receiving element 50, results in a minimum number of parts and thus a cost advantage and a comparatively simple and functionally correct assembly.

1. Brake pressure generator (1), comprising
a hydraulic block (5) having a brake cylinder bore (6),
a piston (30) having a pressure side (33), which projects into the brake cylinder bore (6), and having a coupling side (35) for coupling the piston (30) to an actuating rod (25), wherein the piston (30) extends along a piston longitudinal axis (31) between the pressure side (33) and the coupling side (35),
a receiving element (50) having a connecting section (55) and a sliding guide (70), and
a guide rod (10) fastened to the hydraulic block (5) and offset and oriented parallel to the piston (30),
wherein the sliding guide (70) at least partially engages around the guide rod (10) and can slide along the guide rod (10) during an axial movement of the piston (30),
wherein an axial form fit (80) acts between the coupling side (35) and the connecting section (55), which at least primarily prevents a release of the receiving element (50) in the axial direction (8) from the piston (30), and wherein a circular form fit (81) acts between the coupling side (35) and the connecting section (55), which at least primarily prevents a rotation of the receiving element (50) relative to the piston (30).

2. Brake pressure generator (1) according to claim 1,
wherein a first form-fitting geometry (37), which is encompassed by the coupling side (35), and a second form-fitting geometry (57), which is encompassed by the connecting section (55), form the axial form fit (80), and
wherein a third form-fitting geometry (38), which is encompassed by the coupling side

(35) and a fourth form-fitting geometry (58), which is encompassed by the connecting section (55), form the circular form fit (81).

3. Brake pressure generator (1) according to claim 1,
wherein the axial form fit (80) is formed by an annular web (40), in particular an annular web (40) present on the coupling side (35), engaging behind into a corresponding wall recess (60), in particular into a wall recess (60) present on the receiving element (50), and/or
wherein the axial form fit (80) is an annular, non-releasable snap-action closure.

4. Brake pressure generator (1) according to claim 1,
wherein the circular form fit (81) is formed according to the groove and tongue principle, and/or wherein the circular form fit (81) is formed by an axially extending groove (42) or an axially extending slot (42) in the coupling side (35) and an axially extending web (62) on the receiving element (50).

5. Brake pressure generator (1) according to claim 1,
wherein the receiving element (50) is plugged onto a connecting shoulder (45), situated on the coupling side (35), by means of a connecting bore (65) situated in the connecting section (55), and wherein both the axial form fit (80) and the circular form fit (81) are encompassed by the connecting bore (65) and the connecting shoulder (45).

6. Brake pressure generator (1) according to claim 1,
wherein the sliding guide (70) is arranged on a tab (67) which projects radially from the connecting section (55).

7. Brake pressure generator (1) according to claim 6,
wherein the receiving element (50) has a collar (73) which extends radially outward from the connecting section (55) and is connected to the tab (67), for receiving a compression spring (12).

8. Brake pressure generator (1) according to claim 1,
wherein the receiving element (50) is configured in one piece and is formed from a technical plastic, in particular a polyamide, in particular a fibre-reinforced polyamide, and/or wherein the receiving element (50) is produced by injection moulding.

9. Brake pressure generator (1) according to one of the preceding claim 1,
wherein at least one transducer (15), in particular a permanent magnet, for sensing the travel of the piston (30) is arranged in the piston (30) in such a way that the centre of gravity of the at least one transducer (15) is spaced apart from the piston longitudinal axis (31).

10. Piston arrangement (20) for a brake pressure generator (1), comprising
a piston (30) and a receiving element (50) in each case according to claim 1.
